(19) United States
(12) Patent Application Publication
(10) Pub. No.: US 2026/0109598 A1
(43) Pub. Date: Apr. 23, 2026

(54) SOLID LUBRICANT-DISPERSED METAL HYDRIDES

(71) Applicant: BATTELLE SAVANNAH RIVER ALLIANCE, LLC, AIKEN, SC (US)

(72) Inventors: GEORGE K. LARSEN, AIKEN, SC (US); COLLIN R. MALONE, AUGUSTA, GA (US); CHRISTOPHER S. DANDENEAU, AUGUSTA, GA (US)

(21) Appl. No.: 18/918,197

(22) Filed: Oct. 17, 2024

(51) Int. Cl. C01B 3/00; C01B 4/00

(52) U.S. Cl. CPC C01B 3/0078; C01B 4/00

(57) ABSTRACT

A material for hydrogen isotope storage comprising a metallic matrix including a metal hydride and a solid lubricant dispersed within the matrix.

### STATEMENT REGARDING FEDERALLY SPONSORED RESEARCH OR DEVELOPMENT

This invention was made with government support under Contract No. 89303321CEM000080, awarded by the U.S. Department of Energy. The government has certain rights in the invention.

### BACKGROUND

Hydrogen has gained increasing interest in a variety of applications because it has a very high energy density per unit weight and is essentially a non-polluting agent, while the main by-product of energy release from hydrogen is water. Hydrogen can be produced from a variety of sources and processes. For instance, hydrogen can be produced via syngas generation from coal, natural gas, or hydrocarbons obtained from, e.g., fossil fuels or biomass. Beneficially, hydrogen can also be produced from more environmentally friendly techniques, such as by the electrolysis of water using nuclear, wind, or solar energy.

Hydrogen has wide potential as a fuel and in a variety of devices including, but not limited to, rechargeable batteries (e.g., for electric and hybrid vehicles), pumping and compression systems, and hydrogen absorption coolers. Heavier isotopes of hydrogen (e.g., deuterium and tritium) are also useful for various applications, including research, fusion energy, and defense. However, a major drawback in its utilization has been the lack of acceptable hydrogen storage mediums and systems.

Conventionally, hydrogen has been stored in the gas phase under high pressure or in the liquid phase at extremely low temperatures. Unfortunately, such storage mechanisms require expensive processing and facilities (e.g., high pressure containers and low temperature maintenance). As a result, storage of hydrogen in the solid phase as a hydride has been developed. Solid state hydrogen storage materials that have the ability to efficiently and reversibly store hydrogen are of particular interest with respect to devices that can beneficially employ a controlled absorption/desorption mechanism, particularly those having a large hydrogen-storage capacity. Reversible storage of hydrogen in a solid phase, for instance in the interstitial hydride form, can provide a greater volumetric storage density than storage as a compressed gas or a liquid. Moreover, hydrogen storage in a solid phase presents fewer safety problems than those caused by hydrogen stored in a gas or a liquid phase, particularly when desorption can be well controlled.

Solid phase storage of hydrogen in the form of an interstitial hydride commonly utilizes metals or metal alloys as the solid phase hydrogen absorbent. Interstitial hydrides are traditionally termed ‘compounds’, even though they do not strictly conform to the definition of a compound. They more closely resemble alloys such as steel, and as such are commonly described as incorporating the hydrogen via ‘metal bonding.’ In interstitial hydrides, hydrogen can exist as either an atomic or diatomic entity and the hydride is formed by the absorption and insertion of hydrogen into the crystal lattice of the metal, metal alloy, or a phase of the metal alloy. Interstitial hydride systems are usually non-stoichiometric with variable amounts of hydrogen atoms in the lattice and as such, their absorption capacity can vary greatly between materials and conditions. In general, however, metal hydride systems have the advantage of high-density hydrogen-storage that is effective for long periods of time.

In addition to high storage density capability, good reversibility is desirable in solid state hydrogen storage to enable repeated absorption-desorption cycles without significant loss of hydrogen storage capabilities. Good absorption/desorption kinetics are also generally necessary to enable hydrogen to be absorbed/desorbed in a relatively short period of time.

Over time, intermetallic materials used for storage of hydrogen isotopes can become damaged over time. For example, lattice defects and damage can grow over time in metal hydrides due to hydrogen cycling, He-3 in-growth from tritium storage upon decay within the hydride, or other effects. As such, there is a need to develop metal hydrides that can better withstand long term use for hydrogen isotope storage.

### SUMMARY

According to one embodiment, a material for hydrogen isotope storage is provided. The material includes a metallic matrix including a metal hydride and a solid lubricant dispersed within the matrix.

In another aspect, a method for forming a hydrogen isotope storage material is provided. The method includes ball milling metallic particles and solid lubricant particles to form particles comprising the solid lubricant dispersed within a metallic matrix.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 schematically illustrates a system for storing hydrogen in a solid state form.

FIG. 2 shows a series of tritium sorption isotherms at various ages of a LANA.75 alloy.

FIG. 3 shows hydrogen isotope sorption isotherms for Comparative Samples 1-3.

FIG. 4 shows hydrogen isotope sorption isotherms for Sample 1 and Comparative Sample 2.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

Metals can be used to store hydrogen isotopes in a compact manner through the reversible metal/metal hydride phase transformation. This transition requires overcoming an elastic energy barrier to accommodate lattice expansion during hydrogen absorption. Many metal hydrides, such as AB₅ and AB₂ intermetallic materials, are brittle and must form mobile lattice dislocations to accommodate expansion. As mentioned above, lattice defects and damage can grow over time in metal hydrides due to hydrogen cycling, He-3 in-growth from tritium storage, or other effects, which may further increase the brittleness and prevent the formation of mobile dislocations. For example, He-3 in-growth from tritium storage may reduce dislocation movement, negatively impacting hydrogen sorption in the brittle intermetallic materials. This negatively impacts hydrogen isotope storage properties (e.g., capacity, plateau pressure, trap sites, etc.).

The present inventors discovered that the above negative effects may be prevented by dispersing solid lubricants within the metal matrix, which improves lattice movement and expansion, mitigating damage from lattice expansion. Solid lubricant-dispersed metal hydrides with increased stability and resistance to defects can be used for long term tritium storage or as electrodes in metal hydride batteries.

In general, the present disclosure is directed to material for use in reversible, high-capacity hydrogen isotope storage, systems incorporating the material, and methods for using the material. The material includes a metallic matrix including a metal hydride and a solid lubricant dispersed within the matrix. The material is resistant to the detrimental effects of hydrogen cycling and tritium aging and can therefore have an increased service time.

As used herein, metal hydrides may refer to metallic materials bonded to hydrogen isotopes including protium, deuterium, and tritium. As such, any discussion of metal hydrides may also include metal tritides.

The metallic matric matrix may be any metallic material that can absorb and release hydrogen according to a thermal control mechanism. In one embodiment, the metallic matrix can be one that is capable of forming a metal bond with hydrogen according to an interstitial hydride formation methodology (e.g., capable of forming a metal hydride).

Metal hydrides are formed when a metal is exposed to gaseous hydrogen under particular temperature and pressure conditions (differing depending on the metal). When a metal (M) is exposed to hydrogen (H), the hydrogen permeates through the lattice structure of the metal and, given the required temperature and pressure conditions for that particular metal are achieved, the hydrogen chemically bonds with the metal according to the reaction M+(x/2)H₂ [symbol] MHx (where x=number of hydrogen atoms per metal atom). This forms a dense, stable metallic structure, holding the hydrogen inside the metal. The process can be reversed by heating to or above the required temperature to decompose the metal-hydride.

In general, the metallic matrix can be a crystalline or amorphous material formed of any metal or metal alloy capable of reversibly storing hydrogen within the matrix. By way of example, the metallic matrix can include, without limitation, an element chosen from Group IA alkali metals, Group IIA alkali earth metals, Group IIIB lanthanides, or Group IVB transition metals. In one embodiment, the hydrogen absorbing material can include a transition metal capable of forming a reversible binary metal hydride including, without limitation, palladium, titanium, zirconium, hafnium, zinc, and/or vanadium.

Multi-component metal alloys are also encompassed as reversible hydrogen absorbing materials and can include, without limitation, combinations of Group IV elements with Group V through Group XI elements (based on the 1990 IUPAC system in which the columns are assigned the numbers 1 to 18) as well as alloys including combinations of lanthanides (atomic numbers 58 to 71) with Group VII through Group XI elements. For example; the hydrogen absorbing material can have the structure AₓT_{y} in which A can be one or more Group IV elements and T can be one or more Group V through Group XI elements. In some embodiments, a Group VI metal can be selected from Mo and W, and a Group VIII metal can be selected from Fe, Co, Ni, Pd, and Pt. In some embodiments, a Group VI metal can be Mo and a Group VIII metal can be selected from Co and Ni.

In another embodiment, the hydrogen absorbing material can have a compositional formula of

$${A}_{1 - x} {M}_{x} {T}_{5 - y - z} {B}_{y} {C}_{z} ,$$

$$wherein :$$

$$A = is an alloy of rare earth elements , typically including cerium and lanthanum ;$$

$$M = La , Pr , Nd or Ce ;$$

$$T = Ni ;$$

$$B = Co ;$$

$$C = Mn , Al or Cr ;$$

$$x = 0. to 1. ;$$

$$y = 0. to 2.5 ; and$$

$$z = 0. to 1. .$$

In some embodiments, the metallic matrix may include an AB₅ or AB₂ intermetallic alloy, where A is calcium or a rare earth metal and B is a transition metal, Al, Ge, Si, or Sn. In some embodiments, A is lanthanum and B is nickel (i.e., a lanthanum-nickel alloy, such as LANi₅). In some embodiments, the matrix includes a lanthanum nickel allow in which a portion of the nickel is substituted with aluminum. For example, in some embodiments, the intermetallic has the formula LaNi₅₋ₓAlₓ where x is in the range of 0.01 to 1.5, such as from 0.1 to 1.2, such as from 0.5 to 1, such as from 0.6 to 0.8.

The metallic matrix can be selected to have a desired lattice structure and thermodynamic properties such as to control the pressure and/or temperature at which it can absorb and desorb hydrogen. These working thermodynamic parameters can be modified and fine-tuned by an appropriate alloying method and as such, the composition of the isotope storage material can be designed for use in a particular process.

In some embodiments, the metallic matrix may constitute about 50 wt. % or more, such as about 60 wt. % or more, such as about 70 wt. % or more, such as about 80 wt. % or more, such as about 85 wt. % or more, such as about 90 wt. % or more, such as about 95 wt. % or more, such as about 98 wt. % or more, such as about 99 wt. % or more of the hydrogen isotope storage material. The metallic matrix may constitute about 99.9 wt. % or less, such as about 99.5 wt. % or less, such as about 99 wt. % or less, such as about 98 wt. % or less, such as about 95 wt. % or less, such as about 90 wt. % or less, such as about 85 wt. % or less of the hydrogen isotope storage material.

The kind of solid lubricant is not particularly limited as long as it is a solid having lubricity. Examples of solid lubricants may include, but are not limited to, layered materials, such as chalcogenides. Examples of suitable chalcogenides include, for example, molybdenum disulfide, tungsten disulfide, or a combination thereof. Another suitable layered material is graphite or intercalated graphite. Other solid lubricants that may be used alone or in combination with the layered materials are fluoropolymers (e.g., polytetrafluoroethylene), polyimides, boron nitride (suitably hexagonal boron nitride), soft metals (such as silver, lead, nickel, copper), cerium fluoride, zinc oxide, silver sulfate, cadmium iodide, lead iodide, barium fluoride, tin sulfide, zinc phosphate, zinc sulfide, mica, boron nitrate, borax, fluorinated carbon, zinc phosphide, boron, or a combination thereof.

When the solid lubricant includes graphite, it may be in the form of natural graphite, artificial graphite, activated carbon, acetylene black, carbon black, colloidal graphite, pyrolytic graphite, expanded graphite, or scaly graphite. These graphites may be used alone or in combination of two or more thereof.

In some embodiments, the metallic matrix may constitute about 0.1 wt. % or more, such as about 0.5 wt. % or more, such as about 1 wt. % or more, such as about 2 wt. % or more, such as about 5 wt. % or more, such as about 10 wt. % or more, such as about 15 wt. % or more of the hydrogen isotope storage material. The metallic matrix may constitute about 50 wt. % or less, such as about 40 wt. % or less, such as about 30 wt. % or less, such as about 20 wt. % or less, such as about 15 wt. % or less, such as about 10 wt. % or less, such as about 5 wt. % or less, such as about 2 wt. % or less, such as about 1 wt. % or less of the hydrogen isotope storage material.

The solid lubricant is dispersed within the metallic matrix, which may be in the form of a metal hydride. For example, when hydrogen is contained within the material, the matrix is in the form of a hydride. However, prior to any hydrogen sorption or if the hydrogen has been desorbed from the hydride, the material may comprise a non-hydride metal (e.g., metallic alloy or intermetallic material) with a solid lubricant dispersed therein. In this regard, the matrix may interchangeably include a metal hydride or a metallic material in non-hydride form.

In some embodiments, the solid lubricant may be dispersed uniformly within the metallic matrix. In other embodiments, the solid lubricant may be dispersed non-uniformly within the metallic matrix. For example, there may be a higher concentration of the solid lubricant in the outer regions of the material (e.g., toward the surface of the particles) than in the inner regions of the material (e.g., toward the core or center of the particles).

The hydrogen absorption/desorption capacity of a particular hydride depends on its composition, temperature, and surface area, and on the external hydrogen gas pressure. To maximize the available surface area and the absorption/desorption efficiency, hydrides are often supplied in the form of small-grained particles or pellets.

In this regard, in some embodiments, the material may be in particulate form. The particles may be sized/shaped to have a relatively high specific surface area. For example, the average particle size may be about 5 mm or less, such as about 2 mm or less, such as about 1 mm or less, such as about 500 μm or less, such as about 300 μm or less, such as about 200 μm or less, such as about 100 μm or less. The average particle size may be about 1 μm or more, such as about 10 μm or more, such as about 50 μm or more, such as about 100 μm or more, such as about 200 μm or more, such as about 300 μm or more, such as about 500 μm or more, such as about 1 mm or more. The bulk density of the powder may be from about 2 g/cc to about 7 g/cc, such as from about 3 g/cc to about 6 g/cc, such as from about 4 g/cc to about 5 g/cc.

The shape of the composite particles may also generally vary as desired. For example, in some embodiments, the particles may have the shape of a sphere, plate, rod, disc, bar, tube, an irregular shape, etc. In some embodiments, the shape and size of the particle can be utilized to control hydrogen absorption and desorption characteristics.

The hydrogen isotope storage material may be formed by any suitable method for dispersing a solid lubricant in a metallic matrix. In some embodiments, for example, the material is formed by milling metal hydride/metal alloy particles with the solid lubricant. This technique is generally known as mechanical alloying and may be accomplished using a ball mill.

Mechanical alloying can be performed by repeated physical impact on the composite powder. In an embodiment, the composite powder is transferred from the reactor to a ball mill so that balls (for example, metallic or ceramic balls) mechanically impact the composite powder. In particular, mechanical alloying can be performed using a vibratory ball mill, rotary ball mill, planetary ball mill, or attrition mill, but is not limited thereto. During the milling process, small particles of the solid lubricant may become trapped between particles of the metallic material and incorporated within a matrix formed as the metallic particles are cold welded together.

In some embodiments, the material may be formed by melting the metallic material to be used as the matrix, dispersing the solid lubricant within the molten metal, and cooling the molten mixture to form the storage material. The material can be shaped as desired. For example, the material may be ground/pulverized into particles.

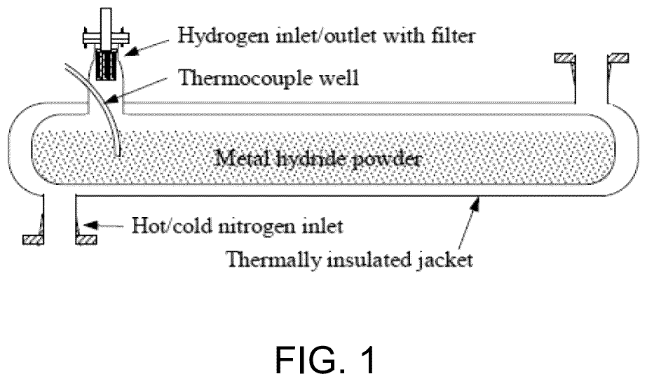

The material may be contained within a hydrogen isotope storage system. A variety of solid state hydrogen storage materials and systems have been developed. For instance, FIG. 1 illustrates a system that includes a bed of metal hydride powder for storing hydrogen in the form of hydrogen isotope storage material particles. In order to control absorption and desorption of the hydrogen, the temperature of the system may be controlled. For example, this may be accomplished through a hot/cold nitrogen (HCN) circulation system, as demonstrated in the illustrated system of FIG. 1, for heating and cooling the bed.

In some embodiments, the storage system includes a vessel containing the hydrogen isotope storage material, a valve for controlling the flow of hydrogen isotopes in and out of the vessel, and a system for controlling the temperature of the interior of the vessel. For example, the temperature control system may include a thermally insulated jacket which contains a heat exchange fluid. The heat exchange fluid may be a gas or a liquid. For example, in some embodiments, the heat exchange fluid contains nitrogen gas. In some embodiments, the system may include other types of temperature control systems alone or in addition to a heat exchange fluid. For example, the system may contain electric heaters.

In some embodiments, to optimize the hydrogen capacity of the storage system while leaving room for expansion of the material with increased sorption, the hydrogen isotope storage material (e.g., lubricant-dispersed metal hydride) may fill from about 50 vol. % to about 90 vol. %, such as from about 60 vol. % to about 80 vol. %, such as from about 65 vol. % to about 75 vol. % of the vessel, using the bulk volume of the material as the basis for its volume.

The storage system is configured to reversibly store and release (e.g., sorb and desorb) the contained hydrogen isotope as desired. To release (desorb) the hydrogen isotope, the temperature can be increased, raising the vapor pressure of the hydrogen isotope within the system. The valve can be opened to release the hydrogen isotope to a connected system. The storage system may be loaded with hydrogen via the opposite process. For example, the vessel can be pressurized with the hydrogen isotope and cooled so the isotope enters the lattice structure of the storage material, forming a hydride.

In some embodiments, the hydrogen isotope storage material may be used as a negative electrode in a metal-hydride battery (e.g., a nickel-metal hydride secondary battery). For example, the anode for a nickel-hydrogen rechargeable battery may contain the hydrogen storage material as an anode along with an electrically conductive material. Examples of the electrically conductive material may include copper, nickel, cobalt, carbon, and the like.

For battery usage, the hydrogen isotope storage material may be in the form of a pulverized material with an average particle size from about 20 μm to about 100 μm, such as from about 40 μm to about 50 μm.

The anode for a nickel-hydrogen rechargeable battery may be prepared, for example, by binding the anode material (e.g., the solid lubricant-dispersed metal hydride and the conductive material) on a collector body of a conductive material such as nickel mesh, nickel or copper expanded metal, nickel or copper punched metal, foamed nickel, and woolen nickel. The binding may be carried out by a rolling press method, a molding press method, or the like into the form of preferably a sheet or a pellet. The binder may include an ethylene tetrafluoride-propylene hexafluoride copolymer (FEP), polytetrafluoroethylene, carboxymethyl cellulose, or the like.

In general, the hydrogen-storage capacity of a hydride may be determined by plotting isotherms of the hydrogen equilibrium pressure (P_{H2}, P_{eq}) versus the hydrogen content of the hydride at a predetermined temperature. At the equilibrium pressure, the partial pressure of hydrogen outside the hydride equals the pressure of the hydrogen absorbed by the hydride. The hydrogen content may be measured in any convenient units, including weight (grams H₂/grams hydride), atomic weight (mols H₂/mols hydride), or the ratio of hydrogen atoms to metal atoms in the hydride (H/M). When considering multiple isotopes of hydrogen, the ratio of hydrogen isotopes (protium, deuterium, tritium) to metal atoms may be expressed as (Q/M).

In a hydride material useful for hydrogen storage, the isotherm generally has a plateau region—a region of approximately constant pressure (the “plateau pressure”) where the hydride absorbs or releases large quantities of hydrogen with relatively small changes in pressure. The plateau pressures for absorption and desorption may be different, a phenomenon known as hysteresis. Useful hydrides have low hysteresis, that is, absorption and desorption pressures are close and long, approximately flat plateaus.

In typical hydrides, the plateau pressure increases with temperature over the useful operating range of the material. The isotherms are also characteristic of the particular hydride and thus, different hydrides have isotherms with different plateau pressures and different Q/M ratios. The plateaus may occur at different pressure levels and may start and end at different Q/M ratios.

As described above, over time, metal hydrides tend to lose their hydrogen isotope storage effectiveness. For example, at a given temperature, the desorption pressure may decrease over time. Additionally, the slope of the plateau region may increase over time. Another issue that may occur in metal hydrides over time is the formation of a heel, which occurs when hydrogen isotopes become trapped within the hydride and do not escape even at high temperatures and low pressures. Any of these detrimental effects may result from the decay of tritium to He-3 that becomes trapped within the matrix.

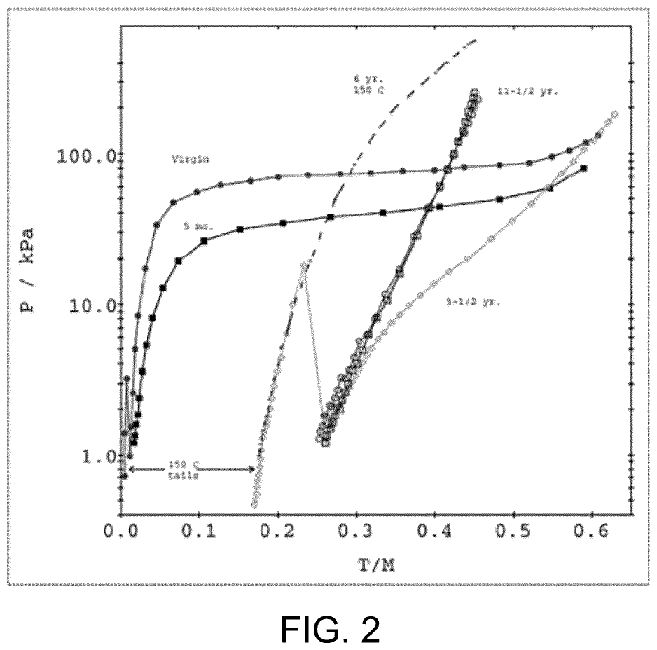

The effects of tritium aging can be seen with reference to FIG. 2, which shows various tritium desorption isotherms at 150° C. for a LaNi_{4.25}Al_{0.75} (LANA.75) alloy. It can be seen that virgin LANA.75 exhibits a relatively flat plateau around 70 kPa with no heel (trapped tritium). After 5 months of aging, the plateau slope is slightly higher and the plateau pressure dropped slightly, but there is still no noticeable heel. After 5.5 years of aging, the plateau slope has increased significantly and there is a clear heel at about 0.17 T/M. After 6 years, the maximum storage capacity has dropped significantly and the plateau slope has increased even further. After 11.5 years of aging, the plateau slope is very steep and the heel has increased even further.

It was found that the hydrogen isotope storage materials described herein exhibit relatively flat plateau regions with low hysteresis and are resistant to the effects of aging. For example, in some embodiments, the desorption pressure of tritium at 80° C. and a stored hydrogen content of 0.35 T/M may be about 100 torr or greater, such as about 200 torr or greater, such as from about 300 torr to about 900 torr after aging with tritium for 800 days. In some embodiments, the plateau slope, defined as the slope of (In(P)/(T/M)) within the center of the plateau region, is about 4 or less, such as about 3 or less, such as from about 0 to about 2 after aging with tritium for 800 days, where P is the pressure in torr. In some embodiments, the amount of irreversible bound tritium (heel) is about 0.5 T/M or less, such as about 0.3 T/M or less, such as from 0 T/M to about 0.2 T/M, such as from about 0 T/M, when measured at 5 torr and 150° C. after 800 days of aging with tritium.

Repeat use of reference characters in the present specification and drawings is intended to represent the same or analogous features or elements of the present invention.

The present disclosure may be better understood with reference to the Examples set forth below.

### EXAMPLE

Various hydrogen isotope storage materials were formed and tested for their effectiveness for resisting the effects of aging.

Ball milling of a hydrogen isotope storage material in a pressurized gas atmosphere simulates many of the effects of tritium aging. For example, milling the material in a pressurized helium, argon, or nitrogen gas can create reduced capacity, sloping plateaus, and heels when the material is tested for hydrogen isotope storage properties following the milling process. As such, the various hydrogen isotope storage materials were tested for their aging resistance using this simulated aging process rather than taking the years of time it would take to age the materials naturally.

Comparative Sample 1 contained 1 wt. % palladium in a LANA.75 matrix.

Comparative Sample 2 contained 0.3 wt. % yttrium oxide in a LANA.75 matrix.

Comparative Sample 3 contained 1 wt. % palladium and 0.3 wt. % yttrium oxide in a LANA.75 matrix.

Sample 1 contained 1 wt. % hexagonal boron nitride in a LANA.75 matrix.

The samples were formed by ball milling the respective additives with LANA.75 powders to disperse the additives within the LANA.75 matrices.

Simulated tritium aging was performed on each of the samples by ball milling them in an argon atmosphere.

After the simulated aging process, the samples were tested for their hydrogen storage characteristics. Testing was performed by measuring the sorption and desorption curves of each sample along a 30° C. isotherm. To collect isotherms, a known amount of hydrogen is introduced to and withdrawn from a system containing the sample, and the pressure is measured after the new solid-gas equilibrium is achieved. A series of hydrogen additions results in an absorption isotherm; a series of subtractions produces a desorption isotherm. The difference in pressures before and after hydrogen exposure allows calculation of the amount of gas absorbed or desorbed from the hydride. The hydride material undergoes a phase transition (α→β or vice versa) as hydrogen is either absorbed or desorbed. The length and slope of the transition plateau region is indicative of the capacity and homogeneity of the hydride, respectively. The solid phase composition is presented as the ratio of hydrogen atoms to metal atoms (Q/M).

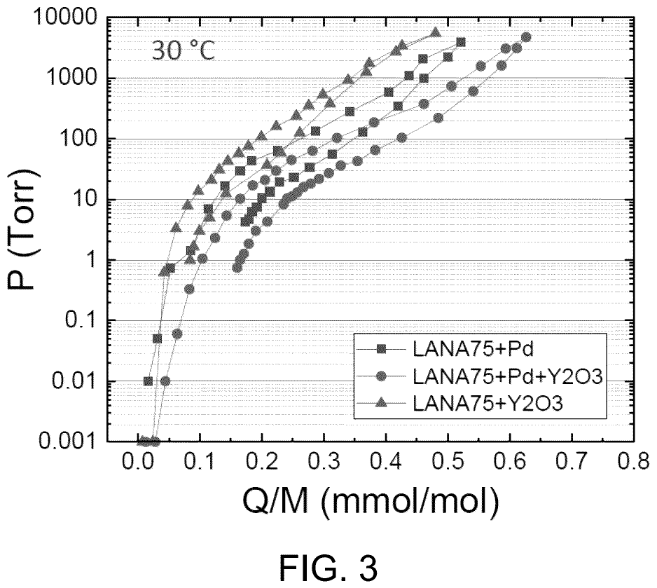

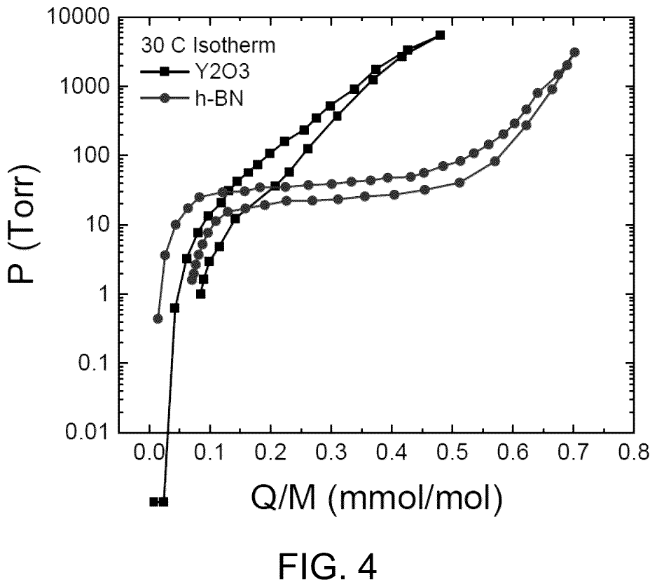

The results of isotherm testing are shown in FIGS. 3 and 4. FIG. 3 contains the isotherms measured for Comparative Samples 1-3. As can be seen, none of the samples exhibits a plateau region with a low slope and heel formation can be seen, particularly for Comparative Samples 1 and 2 containing palladium.

FIG. 4 shows the isotherm measured for Sample 1 and the isotherm measured for Comparative Sample 2 for comparison. It can be seen that the solid lubricant (hexagonal boron nitride) dispersed within the LANA.75 matrix significantly improved the absorption properties. For example, the plateau slope of Sample 1 is much flatter, the absorption capacity is much greater, and the heel is smaller compared to Comparative Sample 2.

While certain embodiments of the disclosed subject matter have been described using specific terms, such description is for illustrative purposes only, and it is to be understood that changes and variations may be made without departing from the spirit or scope of the subject matter.

What is claimed is:

1. A material for hydrogen isotope storage, comprising:
metallic matrix comprising a metal hydride and a solid lubricant dispersed within the matrix.

2. The material of claim 1, wherein the metallic matrix comprises an intermetallic alloy.

3. The material of claim 1, wherein the intermetallic alloy comprises an AB₅ or AB₂ intermetallic, where A is calcium or a rare earth metal and B is a transition metal, Al, Ge, Si, or Sn.

4. The material of claim 3, wherein the intermetallic alloy is lanthanum-nickel alloy.

5. The material of claim 4, wherein the intermetallic has the formula LaNi₅₋ₓAlₓ where x is in the range of 0.01 to 1.5.

6. The material of claim 1, wherein the solid lubricant comprises a carbon material.

7. The material of claim 6, wherein the carbon material comprises graphite or graphene.

8. The material of claim 1, wherein the solid lubricant comprises hexagonal boron nitride.

9. The material of claim 1, wherein the solid lubricant comprises molybdenum disulfide or tungsten disulfide.

10. The material of claim 1, wherein the solid lubricant comprises a fluoropolymer.

11. The material of claim 1, wherein the solid lubricant comprises about 0.5 to 20 wt. % of the metal hydride.

12. The material of claim 1, wherein the material comprises tritium.

13. A tritium storage system comprising a plurality of particles comprising the material of claim 12.

14. A method for forming a hydrogen isotope storage material, the method comprising:
ball milling a mixture of metallic particles and solid lubricant particles to form particles comprising the solid lubricant dispersed within a metallic matrix.

15. The method of claim 14, wherein the metallic matrix comprises an intermetallic alloy.

16. The method of claim 15, wherein the intermetallic alloy comprises an AB₅ or AB₂ intermetallic, where A is calcium or a rare earth metal and B is a transition metal, Al, Ge, Si, or Sn.

17. The method of claim 16, wherein the intermetallic alloy is lanthanum-nickel alloy.

18. The method of claim 17, wherein the intermetallic has the formula LaNi₅₋ₓAlₓ where x is in the range of 0.01 to 1.5.

19. The method of claim 14, wherein the solid lubricant comprises graphite, graphene, hexagonal boron nitride, molybdenum disulfide, tungsten disulfide, or a fluoropolymer.

20. The method of claim 14, further comprising incorporating tritium within the hydrogen isotope storage material.
